(19) United States
(12) Patent Application Publication
(10) Pub. No.: US 2025/0158473 A1
(43) Pub. Date: May 15, 2025

(54) Electric Rotating Machine With a Can

(71) Applicant: Siemens Mobility GmbH, München, Bayern (DE)

(72) Inventors: David Finck, Forchheim (DE); Felix Ntourmas, Coburg (DE); Christian Seidel, Baiersdorf (DE); Olaf Körner, Nürnberg (DE); Wolfgang Wetzel, Herzogenaurach (DE); Martin Johannes, Erlangen (DE); Johann Stapfner, Stein (DE); Christoph Adam, Nürnberg (DE); Johannes Großhauser, Wendelstein (DE)

(73) Assignee: Siemens Mobility GmbH, München, Bayern (DE)

(21) Appl. No.: 18/834,420

(22) PCT Filed: Dec. 29, 2022
(86) PCT No.: PCT/EP2022/088021

§ 371 Date: Jul. 30, 2024

(30) Foreign Application Priority Data
Jan. 31, 2022 (EP) 22154323.4

(51) Int. Cl. H02K 5/10

(52) U.S. Cl. CPC H02K 5/10

(57) ABSTRACT

Various embodiments of the teachings herein include an electric rotating machine or liquid pump. An example includes: a first liquid-free area; a second liquid-containing area; a can separating the first area from the second area, the can defining a stator-side and a rotor-side; and a sealing element at an axial end of the can. The sealing element is arranged symmetrically with respect to force effect on the can so that forces acting at the axial end of the can due to the seal are equalized.

### CROSS-REFERENCE TO RELATED APPLICATIONS

This application is a U.S. National Stage Application of International Application No. PCT/EP2022/088021 filed Dec. 29, 2022, which designates the United States of America, and claims priority to EP Application No. 22154323.4 filed Jan. 31, 2022, the contents of which are hereby incorporated by reference in their entirety.

### TECHNICAL FIELD

The present disclosure relates to electric rotating machines. Various embodiments of the teachings herein include can for electric rotating machines and electric rotating machines, such as an electric motor, a generator, a wind generator, and/or a liquid pump.

### BACKGROUND

Increasing the power density of electric rotating machines is increasingly important in the electrified field of mobility, e.g. in electrically powered vehicles such as buses, passenger cars, commercial vehicles, trains and ships, and aircraft, because more powerful motors can save material and/or weight. For this reason, liquid-cooled electric rotating machines, in particular electric motors, are increasingly used.

The electrical power density of an electric motor and/or generator is determined by the waste heat produced and the associated problems. One problem, for example, is the failure of the polymer insulation of the winding coils in the laminated core of the stator of each electric motor. Therefore, the maximum temperature in the stator winding is also typically a particularly critical point in the development of higher power densities in the electric motor.

The trend towards liquid cooling, particularly through direct oil cooling, is due to the higher waste heat flow that can be achieved through liquid cooling compared to gas-air cooling. In the case of liquid-cooled electric motors, it is generally the stator with the laminated core and with the winding coils encapsulated in polymer that is cooled, not the rotor. The rotor is less sensitive to heat than the laminations of the stator, which have a polymer encapsulation.

Jacket cooling of the stator provides reasonably good cooling results. More direct cooling can be achieved with a canned construction in which a cooling liquid, in particular an oil with good cooling properties, circulates on the inside of the coil. In order to avoid frictional losses of the rotor in the liquid, a so-called can in the air gap may separate the liquid from the rotor area. For example, cans are used in the liquid cooling of the stator, where the liquid-free area of the rotor is hermetically sealed from the liquid-containing area of the stator. The can seals the area of the stator filled with the coolant, wherein the can is arranged with its axial ends in a radial gap.

An electric rotating machine with a higher power density also may have advantages in mobile applications. The more compact design enables easier installation positions and the higher power density also provides lightweight construction, as a smaller electric rotating machine can be used for the required power. However, there are also advantages in stationary applications, such as wind turbines. Here, the lower generator mass means that the entire tower structure can be made less massive. The thermal service life of the stator windings used can also be better estimated and extended thanks to the improved heat dissipation.

The design preferences for a can of the type mentioned at the outset may include:
a) Minimal wall thickness: The thicker the can, the greater the magnetic losses of the electric rotating machine. In order to minimize the negative influence on the magnetic properties of the machine, it is therefore necessary to keep the wall thickness of the can as low as possible.
b) Greatest possible dimensional stability under external pressure: The pressurized liquid cooling system exerts an external pressure load on the can. This pressure load deforms the can depending on its dimensional stability. The deformation is taken into account when designing the air gap width and thus increases the magnetic losses. The maximum system pressure depends on the operating scenario and is composed—for example—of variable component(s), such as acceleration, pressure surges, etc., and constant component(s), such as gravity acting on the fluid column.
c) Greatest possible buckling stability: Due to the mainly existing external pressure load, a failure of the can during operation is to be expected mainly due to buckling. The requirement of a high dimensional stability against external pressure as already mentioned above, so that above all a high stiffness of the can is required. For the design of the can during construction, it is crucial that the external pressure maintains a certain minimum distance to the so-called “critical point” of dimensional stability of the can. This “critical point” is also known as the “buckling point” and is shifted to higher pressures by using stiffer materials and/or greater wall thicknesses.
d) Electrical conductivity: As the can is exposed to changing magnetic fields in the air gap, the electrical conductivity of the can should, in principle, be as low as possible. The induction of excessive eddy currents into the can leads to a reduction in the electrical efficiency of the electrical rotating machine and to heating of the can, which also has a negative effect on the temperature-dependent structural properties of the can.

Therefore, a can is typically thin-walled and non-magnetizable metallic or polymeric, for example at least partially fiber-reinforced. The can, as mentioned above, is the separating wall between the liquid-filled and liquid-empty areas in the housing of the electric rotating machine. A key element for functioning operation is, above all, a reliable seal between the two areas mentioned.

DE 10 2020 121 707 B1 discloses an electric machine with a directly cooled stator, a rotor, and a can. The can is arranged in an annular gap between the stator area and the rotor area. A seal is arranged on the inside of the can at each axial end of the can. The seal is arranged here in a housing part of the electric machine and presses against the axial end of the can due to the pressure load of the cooling liquid in the stator area. The contact pressure of the sealing element leads to a one-sided load on the can during operation. Further, an additional support element must be arranged on the housing of the electric machine for the seal.

### SUMMARY

The teachings of the present disclosure engage the disadvantages of the prior art and describe a seal for a can of an electric rotating machine which places as little stress as possible on a thin-walled can and is of the simplest design possible. For example, some embodiments of the teachings herein include an electric rotating machine or liquid pump, comprising: a first area which is liquid-free, a second area which is liquid-containing, and a can which separates the two areas from one another sealingly. One or more elements (2, 6, 7) are provided at each axial end on the stator-side and rotor-side surface of the can (1), wherein the elements (2, 6, 7) are identical, non-identical, encasing and/or act on both sides, wherein the element or elements (2, 6, 7) are arranged symmetrically on the rotor and stator sides with respect to their force effect on the can, so that the forces acting at the axial end of the can (1) due to the seal are equalized.

In some embodiments, an element (6, 7) is provided at each axial end of the can (1).

In some embodiments, two elements (2) are provided at each axial end of the can (19).

In some embodiments, an optically symmetrical arrangement of the elements (2, 6 and 7) is provided on the inside and outside of the can (1).

In some embodiments, at least one sealing element is provided.

In some embodiments, at least one sealing element is provided in the form of an O-ring.

In some embodiments, at least one receiving device (3, 4) is provided, by which at least one element (2, 6 7) is held in position.

In some embodiments, at least one support structure (5, 8 and 9) is provided, in which at least one receiving device (3, 4) is arranged.

In some embodiments, a receiving device (3, 4) is designed in the form of a groove.

In some embodiments, at least one support structure (5, 8 and 9) is part of the housing.

In some embodiments, at least one support structure (5, 8 and 9) is part of the end shield.

In some embodiments, at least one sealing element (6, 7) comprises sealing lips.

In some embodiments, at least one sealing element comprises a sealing lip.

In some embodiments, at least one receiving device (3, 4) and/or a support structure (5, 8 and 9) comprises a bulge and/or lug.

In some embodiments, two sealing lips surround and seal the can (1) during joining and mounting of the can in the receiving device.

### BRIEF DESCRIPTION OF THE DRAWINGS

The teachings of the present disclosure are further explained in greater detail with reference to figures showing a simulation of a simple U-groove and double O-ring exemplary embodiment. In the drawings:

FIG. 1 shows the result of a simulation of reference constructions of two sealing elements, each applied on one side, compared to a system incorporating teachings of the present disclosure;

FIG. 2 schematically shows an example system incorporating teachings of the present disclosure with a trapezoidal groove and double-O-ring seal on the can;

FIG. 3 shows the embodiment of FIG. 2 in detail with insertion bevels and drain;

FIG. 4 shows another example embodiment of the present disclosure with a sealing element that engages around on both sides; and

FIG. 5 shows another example embodiment of the teachings herein with a sealing element that engages around on both sides.

### DETAILED DESCRIPTION

Teachings of the present disclosure include an electric rotating machine having: a first area which is liquid-free, in particular with a rotor, a second area which is liquid-containing, in particular with a stator, and a can which separates the two areas from one another sealingly. One or more elements are provided at each axial end on the stator-side and rotor-side surface of the can, wherein the elements are identical, non-identical, encasing and/or act on both sides, wherein the element or elements (2, 6, 7) are arranged symmetrically on the rotor and stator sides with respect to their force effect on the can, so that the forces acting at the axial end of the can (1) due to the seal are equalized. The technical teaching disclosed here can be realized on electric rotating machines just as on liquid pumps, wherein the liquid-containing area of the pump is not that of the electric rotating machine, but the function of the can remains the same. The fitting of sealing elements on both sides prevents the can from bending at the axial end due to the contact pressure of a seal fitted on one side. Sealing of the can by means of sealing elements arranged on both sides of the axial end of the can has a beneficial effect on the entire concept of the can.

In the present case, the term “element” refers to a pressure element, for example a “sealing element” and/or an element for stabilizing the can at the point. A sealing element is provided at least on the stator side, i.e., on the side of the can on which the liquid that cools the stator is located. Examples of sealing elements are, in particular, elastomeric shaped bodies which, due to the pressure exerted on them by the liquid, fit even better sealingly against the can and between the can and the housing or end shield. For example, the sealing element known from DE 10 2020 121 707 B3 is a suitable shaped body that can be used on the stator side.

Furthermore, the term “sealing element” in the present case refers, for example, to an O-ring, an annular groove lining, a sheathing of the axial end of the can and/or similar shaped bodies that seal the axial end of a cylindrical body from the circumference and may be made of a rubber-elastic material and/or an elastomer. Suitable shaped bodies that can be used as a sealing element or as an element are also disclosed by the figures together with the description thereof.

In some embodiments, for example, two O-rings are fitted to seal each axial end of the can. One or both O-rings are arranged, for example, in a corresponding support structure, such as an annular groove, which in turn is provided, for example, around the air gap.

It should be noted in particular that a sealing element under pressure, such as here under fluid pressure, generally exerts a not inconsiderable local stress on a fragile can, because the latter is designed to be as thin-walled as possible. Experience has shown that the locally generated stresses even reach design limits, for example for typical cans made of fiber composite materials. Teachings of the present disclosure may be used to prevent a can, which is made for example of fiber composite material, typically produced in a winding process with an electrically conductive reinforcing fiber, such as a carbon fiber, which may be laid along the circumference of the can, from being bent by attaching an element on one side, in particular a sealing element and for example an O-ring, at the point where the element is attached.

A bending of the can at the axial end, where in particular a sealing element is provided so that the liquid does not pass from the stator area into the rotor area, occurs, for example, in a can made of fiber composite material. The can is wound from fiber composite material, wherein for the highest possible dimensional stability of the can—as already mentioned at the outset with regard to the risk of buckling—against external pressure and low susceptibility to eddy current losses, an orientation of the reinforcing fiber in the can runs as close as possible in a tangential direction, i.e., along the circumference of the can—as known from DE 10 2020 205286. A winding of this embodiment—which requires, for example, a laminate structure of a can—has the disadvantage, however, that it gives the can little reinforcement in the axial direction, so that the fiber-reinforced can wound in this way has little stiffness and little strength in the axial direction.

An element that is fully attached to the axial end of a can, such as an O-ring, requires a certain minimum contact pressure in the fluid-loaded stator area in order to seal effectively, so that sufficient tightness against the fluid leakage from the stator area results. This is all the more important as the positional stability under load of the can is also influenced and advantageously reinforced by this element.

The resulting compression of an element such as a sealing element, for example in the form of an O-ring, is then accompanied by a bending up of the can and generates local internal bending and shear stresses in the can, wherein the stress components running in the axial direction in particular are not sufficiently counterbalanced by the fiber reinforcement of the fiber composite material due to the winding structure described above. In addition, there is a risk that, depending on the wall thickness, the can will be bent up to a critical extent, which has a negative effect on the compression of the element, such as the O-ring.

In some embodiments, a double O-ring system is used, for example, to balance the forces acting on the can and/or the corresponding stress components. For this purpose, two O-rings, also of approximately the same quality, are installed in grooves on both sides, so that the same elements are present on at least one axial end of the can on the rotor side and stator side of the can.

The forces of the two sealing and/or bearing elements—when arranged symmetrically on the stator and rotor sides at the respective axial end of the can—at least partially balance each other out, so that the can may be mounted virtually stress-free. This means that the disadvantages resulting from the circumferential winding of the can play no or only a subordinate role, because no significant internal stresses occur in the axial direction.

In some embodiments, the two elements are present as sealing elements in the form of O-rings. In some embodiments, the elements are held in place by a receiving device, for example in the form of a groove. In some embodiments, the O-rings are embedded in a trapezoidal groove. Assembly may be simplified because the O-rings can be easily fixed in the trapezoidal grooves. This may be advantageous when mounting the external O-ring, i.e., in so-called “overhead mounting”. By attaching a receiving device, such as the groove, it can be ensured that the two elements are mounted symmetrically on the can opposite each other and do not move during operation. From a current perspective, the concept of a U-shaped groove therefore seems less suitable than the trapezoidal groove.

By fixing the O-rings in the groove, twisting and/or turning of the O-rings can also be suppressed as far as possible. The O-rings are axially fixed in comparison to the U-shaped groove and are therefore exactly opposite each other. This is the only way to ensure that the force compensation functions effectively. In a U-shaped groove, the O-ring has more axial play.

In some embodiments, one or more annular grooves provided as a receiving device for the element or elements are not rectangular in shape but, for example, round, serrated, ribbed, with a sticky and/or rough surface texture—especially on the inside—or trapezoidal with an inwardly widening cross-section. The receiving device is provided, for example, in a support structure. The one or more support structure(s) can in particular also be an integral part of the housing of the electric rotating machine and/or also part of the end shield.

In some embodiments, the support structure can, for example, be made of metal, a metal alloy, steel, ceramic and/or a lightweight material such as a fiber composite. A fiber composite material is a multi-phase or mixed material generally consisting of two main components—a bedding matrix and reinforcing fibers. Mutual interactions between the two components give it higher quality properties than either of the two individual components involved. Fiber composite materials include, for example, synthetic resins such as thermosetting synthetic resins as the bedding matrix. Glass fibers, carbon fibers, aramid fibers, ceramic fibers and others can be used for fiber reinforcement.

The one or more support structure(s) can in particular also be an integral part of the housing of the electric rotating machine and/or also part of an end shield. In some embodiments, a bearing that is twice as rigid as a single O-ring for the can is produced, and therefore movement tolerances in the air gap are lower. Due to the extensive freedom from load on the can, significantly stiffer sealing materials can also be used in comparison to a bearing with a single sealing element without an opposing counter element. The stiffer sealing elements also contribute to a stiffer bearing. The possibility of using a wide range of seal stiffnesses means that a wider market availability is also possible at a lower purchase price. If two sealing elements are fitted on the stator and rotor side, there is improved sealing reliability to the rotor, as the cooling fluid from the stator area has to overcome two sealing elements.

It could be problematic that the liquid in the stator area collects in a pocket between the sealing elements and/or begins to pump due to movement of the can and pushes through the seals. For this reason, a preferred embodiment of the invention also provides for the attachment of a drain on the stator side.

Quite generally, there is improved sealing reliability to the rotor, as the can is not bent up due to one-sided loading by a sealing element.

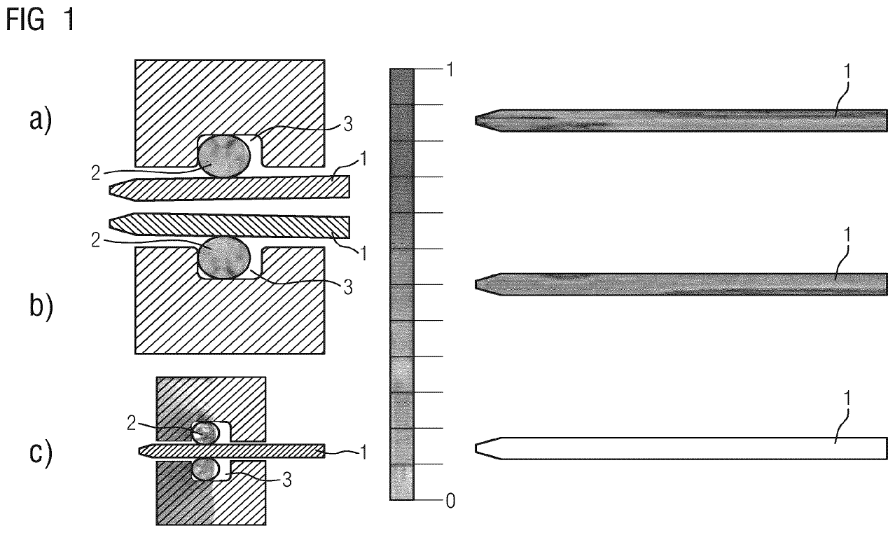

FIG. 1 shows the images from tests into the stress situation when attaching sealing elements, in this case O-rings, to cans made of fiber composite material—FRP cans—with the advantageous can circumference described, in particular 80° to 90° winding, and different O-ring installation situations, namely:
a) one-sided externally,
b) one-sided internally,
c) exemplary embodiment of the invention—on both sides, form-fittingly and symmetrically on the stator and rotor sides in relation to the forces acting at the sealed point on the can.

FIG. 1 shows the result of the simulation of the stress distribution and/or laminate stress caused by the various O-ring arrangements a) to c). The simulation showed that the O-ring bearing on both sides has the mechanical advantages described. In FIG. 1, U-grooves have been used to simplify the simulation. It can be clearly seen that the can is visibly bent up both at the outer seal and at the inner seal with a single-sided O-ring arrangement and that the laminate stress is significantly higher than with the double-sided O-ring arrangement according to the invention. The so-called Tsai-Wu factor evaluates the existing internal stress states in the material against the failure limits (strengths) of the FRP material used and is therefore an indicator of the existing laminate stress. The higher the Tsai-Wu factor, the higher the laminate stress. In the present case, internal tensile stresses in the axial direction in particular occur in the can with the variants of the O-rings arranged on one side. For the FRP material in question, these represent a transverse stress in which, as described, only low strengths are present, resulting in comparatively high Tsai-Wu values.

Due to the double-O-ring arrangement, the Tsai-Wu laminate stress factor in the present case can be reduced from at best 0.29 (outer seal) or 0.15 (inner seal) to 0.04, which corresponds to a reduction in stress of approximately 73%. For the purposes of this description, on the inside and outside of the can means on the inside of the rotor and on the outside of the stator.

FIG. 1 shows three comparative examples, each in cross-section. At the top is the outer seal—i.e. on the stator side with an external seal on one side of a can 1 using an O-ring 2, which is mounted in a U-groove 3. The resulting stresses in can 1 are illustrated on the right. The illustration beneath from FIG. 1 describes the same simulation result for an internal seal, i.e. on the rotor side, again with a cross-section through an axial end of a can 1, with an O-ring 2, and a U-groove 3. The resulting stresses are again illustrated to the right in the gap.

Lastly, at the bottom of FIG. 1, because it is the least stressed, a construction of a can sealing incorporating teachings of the present disclosure can be seen. There, a double-sided arrangement of the O-rings 2 in a U-groove 3 on both sides of the axial end of the can 1 can be seen. This design results in the lowest stress and/or laminate stress acting on the can 1, approximately zero on the Von-Mises stress scale in [MPa](center) and approximately zero on the Tsai-Wu laminate scale (right). The simulations again refer to an earlier development phase in which U-grooves were used for the O-rings. However, the results should also apply to trapezoidal grooves, as the O-rings do not move against each other in the load case examined.

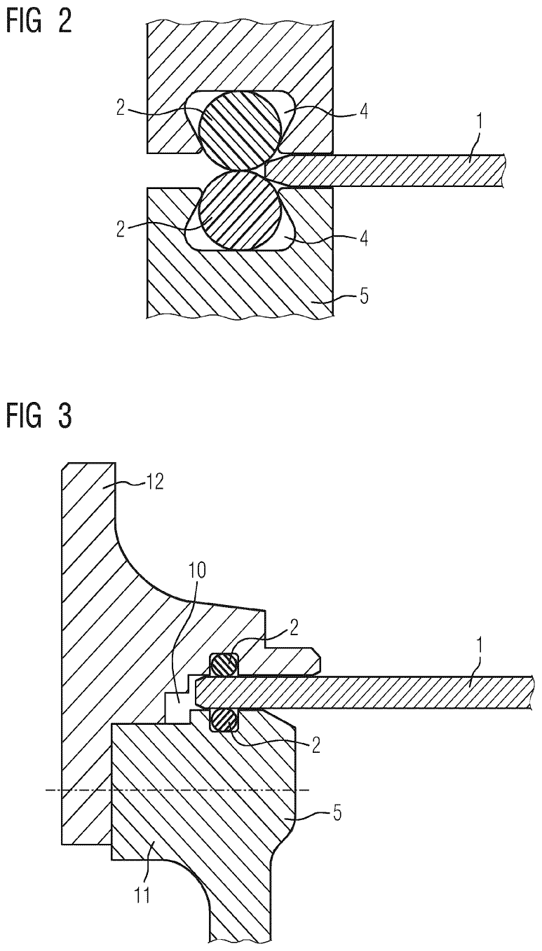

FIG. 2 schematically shows an example system with two elements at each axial end of a can 1. The can 1—of which only the portion at one axial end is shown in cross-section—can be seen directly during assembly before the thin-walled can 1 is inserted into the sealing structure provided by two O-rings 2. The sealing structure comprises the two O-rings 2, which are held in position symmetrically by the two support elements 5, each of which has an identically shaped trapezoidal groove 4. Since the two O-rings 2 are made of elastic material, the can 1 can be pushed through the two contacting O-rings 2 by means of the insertion chamfers, thereby pushing them apart and into the trapezoidal groove 4, so that the positioning and sealing construction of the can 1 is fixed.

The structurally more complex solution of the seal shown in FIG. 2 is shown in FIG. 3. As in FIG. 2, FIG. 3 again shows the design with double O-ring 2—this time mounted in simple U-grooves. FIG. 3 again shows only a portion at the axial end of can 1 in cross-section, but this time—in contrast to FIG. 2—not before assembly, but in an already assembled state. The axial end of can 1 with the insertion chamfers is therefore already positioned between the two O-rings 2. The receiving device for the sealing elements, shown here in the form of simple U-grooves, serve to hold the O-rings 2 and are each housed in a support structure 11 and 12. The support structure 12 has further features such as a drain 10. The support structures 11 and/or 12 can be designed as part of the housing of the electric rotating machine and/or as part of an end shield.

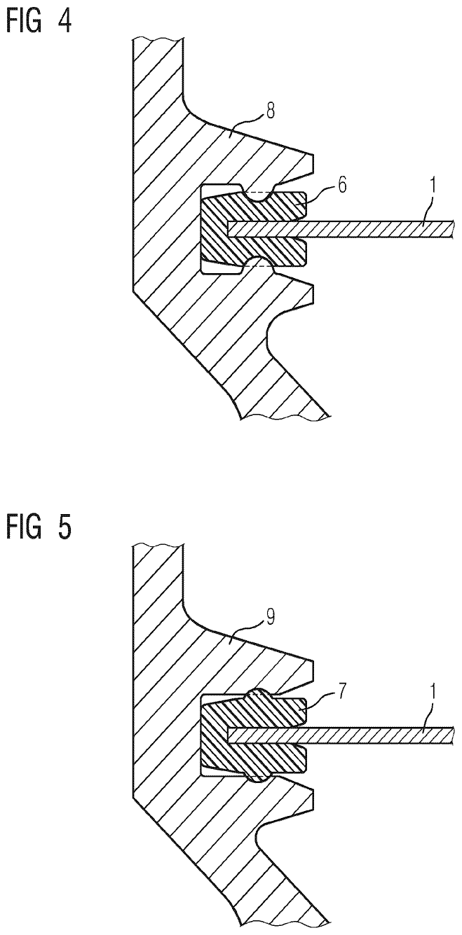

FIG. 4 shows another example system incorporating teachings of the present disclosure with a single element 6, which acts symmetrically on both sides—the axis of symmetry runs along the can—to seal the can 1. The sealing element 6, for example made of rubber-like and/or elastomeric material, completely encases the axial end of a can 1 and is held in the support structure 8 by small bulges or “lugs”. Due to the sheathing that the sealing element 6 shows in relation to the axial end of the can 1 according to the embodiment shown in FIG. 4, symmetrical forces act on both sides of the can 1. In some embodiments, equal loads are exerted on the can here. The lug size is set by design in such a way that sufficient compression of the sealing element can be ensured so that a sufficiently high surface pressure prevails between the sealing element and the can, which has a sufficiently high level of safety against the passage of liquids.

The construction shown in FIG. 5 is based on the same technical principles. Once again, an axial end of a can 1 can be seen in cross-section, encased on both sides by a single sealing element 7, wherein the sealing element is held in position within the support structure 9 by bulges or “lugs”.

The principle for designing a receiving device 3, 4 for the sealing element 2, 6 and 7 and/or a support structure 5, 8 and 9, due to the load on the sealing element 2, 6 and 7 during operation—on the one hand caused by the liquid in the stator area and on the other hand caused by the bearing of the can 1—this sealing element 2, 6 and 7 is pressed deeper into and/or closer to the receiving device 3 and 4 and/or support structure 5, 8 and 9.

The two elements 6 and 7 shown in FIGS. 4 and 5 are more complex sealing elements than the O-rings in FIGS. 2 and 3 and are not necessarily standard on the market. They are distinguished, for example, by the presence of sealing lips that adjoin the side of the axial end of the can and encase it. In particular, these are sealing elements which, in addition to the sealing lips, also comprise a main body which fits into the support structure and/or a corresponding receiving device. In some embodiments, the two sealing lips surround and seal the can when the can 1 is joined and mounted in a receiving device, for example in the sealing gap.

Some embodiments of the teachings herein may provide:
The groove surrounding the sealing lips can be filled with a hardening liquid sealing material, especially before the joining process with the can 1. The sealing material is able to fill and even out the possibly rough and porous surface of the can 1 made of fiber composite material (FRP), thus creating a reliable seal against the cooling liquid.
Due to the opposing sealing lips, which are arranged symmetrically in relation to the forces acting on the can, the sealing lip forces acting on the can are balanced out and the can may be mounted almost stress-free.

The two embodiments of the sealing elements 6 and 7 in FIGS. 4 and 5 differ from the double O-ring solution in the method used to press the sealing element onto the can. In FIG. 4, protruding lugs of the support structure 8, which is an integral part of the end shield in this case, for example, press into the sealing element 6. It would also be conceivable to integrate the support structure 8 into the housing. In FIG. 5, protruding lugs of the sealing element 7 press against the wall of the support structure 9. In principle, both variants should have a similar performance in terms of the sealing effect, although the variant in FIG. 4 is probably more complicated to manufacture.

The special design feature of these embodiments of the invention shown in FIGS. 4 and 5 is that a sealing concept superior to typical sealing arrangements is presented for cans in general and FRP cans in particular, wherein a special sealing element is developed in which the contact pressure force of the sealing lip actually providing the sealing effect is compensated by an opposing sealing lip. The opposing sealing lip design thus compensates for the disadvantage of the low axial reinforcement of an extremely rigid (CFRP) circumferential winding in the radial direction in the manufacture of the can by completely preventing the cause of critical local bending of the can, namely the reaction force of the O-ring on the can, by means of the special sealing element in accordance with the exemplary embodiments in FIGS. 4 and 5. This sealing technology also offers the advantage of connecting the typically rough and porous FRP surface of the can to the sealing element using a liquid seal. This ensures uncomplicated and safe use of the CFRP circumferential winding in a can in an electric machine, which is advantageous in terms of structure and eddy current losses.

Due to the deformability of a soft material, an O-ring that is smaller and stiffer can transmit the same amount of force as a thicker, larger O-ring. The stiffness of a material is determined and measured by the modulus of elasticity. Thus, a pair of O-rings of different materials and shapes, which are arranged symmetrically, form-fittingly and with the same force effect on the inside and outside of the can, is within the scope of the invention because the sealing elements exert a symmetrically acting force on the can in a stabilizing manner.

Symmetry of the forces acting on the can through the elements 2, 6 and/or 7 refers to the inner and outer surface of the can. The plane of symmetry falls on the can. In some embodiments, the elements 2, 6 and/or 7 are optically symmetrical, so that they fall, for example, under one of the embodiments as shown in FIGS. 2, 3, 4 and 5.

In some embodiments, the elements 2, 6 and/or 7 are identical in terms of their material on both sides of the can. The form fit of the sealing element, which acts symmetrically on the inside and outside of the can, exerts an equal force on the inside and outside of the can, i.e. on the rotor and stator sides, which stabilizes the can against buckling.

In some embodiments, the symmetrically arranged sealing elements are of the same hardness/stiffness so that a force balance is achieved. If sealing elements of different sizes are used, the force transmitted to the can must be kept in balance. This is the case, for example, if a large, soft O-ring on the inside is opposed to a small and hard O-ring on the outside, because a large, soft O-ring can generate just as much force as a small, hard O-ring. The symmetrical force effect may avoid bending a thin-walled can, as this could lead to leakage and thus motor failure.

The novel double-O-ring design and the embodiments with an encasing element as shown in FIGS. 4 and 5, for example, have been able to significantly reduce the stress on the can. As a result, the sealing technology is not the limiting factor for the wall thickness of the can in many typical can designs. Thinner wall thicknesses are therefore possible, which brings with it a wide range of other advantages. In addition, pure circumferential windings of the can are conceivable, which allow particularly high loading pressures, as no significant stress on the can is to be expected during operation. Experience has shown that the bearing of the can represents the highest stress. The actual operating load on the can, the external pressure, hardly generates any laminate stress. Only when the critical buckling pressure is reached and the structural integrity of the can is lost are stresses that could endanger the strength of the can reached.

DE 10 2020205287 A1 discloses a can comprising CF-HM/UHM “high modulus and ultra-high modulus carbon fibers” composite materials. The teachings herein may simplify the use of an extremely stiff CF-UHM fiber, which enables enormously high buckling pressures, since a pure circumferential winding in the CF-UHM layer is possible. The pure circumferential winding of the CF-UHM fiber may minimize eddy current losses in the can. Due to the pure circumferential winding, no pronounced conductive structures can form in the can.

However, the can may also be implemented with other fibers or completely different—in particular lightweight materials other than CF-UHM fibers. In addition, the reduced radial can deformations have significantly simplified the design of the elastomer seals. Reduced bending of the can due to the elastomeric seal also leads to a more reliable sealing effect, since surface pressures between the O-ring and can and O-ring and housing can be realized.

The present disclosure describes a low-stress, laminate-protecting and/or approximately load-free mounting of the can of an electric rotating machine, because the sealing concept provides for a double-sided, in particular a double-sided and symmetrical loading of the can.

What is claimed is:

1. An electric rotating machine or liquid pump comprising:
a
first liquid-free area;
second liquid-containing area;
a can separating the first area from the second area, the can defining a stator-side and a rotor-side; and
a sealing element at an axial end of the can;
wherein the sealing element is arranged symmetrically with respect to force effect on the can; so that forces acting at the axial end of the can due to the seal are equalized.

2. The electric rotating machine or liquid pump as claimed in claim 1, further comprising a sealing element at each axial end of the can.

3. The electric rotating machine or liquid pump as claimed in claim 1, comprising two sealing elements at each axial end of the can.

4. The electric rotating machine or liquid pump as claimed in claim 1, comprising an optically symmetrical arrangement of multiple sealing elements on the inside and outside of the can.

5. (canceled)

6. The electric rotating machine or liquid pump as claimed in claim 1, wherein the sealing element comprises an O-ring.

7. The electric rotating machine or liquid pump as claimed in claim 1, further comprising a receiving device holding the sealing element in position.

8. The electric rotating machine or liquid pump as claimed in claim 7, further comprising a support structure in which the receiving device is arranged.

9. The electric rotating machine or liquid pump as claimed in claim 7, wherein the receiving device comprises a groove.

10. The electric rotating machine or liquid pump as claimed in claim 8, wherein the support structure is part of the housing.

11. The electric rotating machine or liquid pump as claimed in claim 1, wherein the support structure is part of the end shield.

12. The electric rotating machine or liquid pump as claimed in claim 1, wherein the sealing element comprises sealing lips.

13. The electric rotating machine or liquid pump as claimed in claim 1, wherein the sealing element comprises a sealing lip.

14. The electric rotating machine or liquid pump as claimed in claim 8, wherein the receiving device and/or the support structure comprises a bulge and/or lug.

15. The electric rotating machine or liquid pump as claimed in claim 1, further comprising two sealing lips surrounding and sealing the can during joining and mounting of the can in the receiving device.
